(19) United States
(12) Patent Application Publication
(10) Pub. No.: US 2008/0117068 A1
(43) Pub. Date: May 22, 2008

(54) Intelligent Network Alarm Status Monitoring

(76) Inventor: Mark Henrik Sandstrom, Calgary (CA)

Correspondence Address: FENWICK & WEST LLP, SILICON VALLEY CENTER, 801 CALIFORNIA STREET, MOUNTAIN VIEW, CA, 94041, US

(21) Appl. No.: 11/563,079

(22) Filed: Nov. 24, 2006

Related U.S. Application Data
(60) Provisional application No. 60/866,208, filed on Nov. 16, 2006.

(51) Int. Cl. G08B 21/00

(52) U.S. Cl. 340/635

(57) ABSTRACT

Systems and methods enable automated, transparent and efficiently scalable alarm monitoring, display, notification, redundant alarm suppression and root-defect resolution in telecom networks, resulting in transparent visibility with intuitive navigation from a network management GUI down to the network element hardware status registers of concern. A logical alarm propagation hierarchy enables efficient root defect resolution in large networks with extensive amounts of individual defects capable of causing alarms, based on hyperlinked navigation from top-level NE alarm indicators down to bottom-level defect status registers. Un-monitored defects (e.g., non-service affecting defects) are prevented from causing unnecessary alarms, and alerts are produced to notify the network operations staff of new NE alarms. Techniques are used to minimize the frequency of such alarm notifications while providing a comprehensive and clear view of the network alarm status, even under heavy loads of defect activity.

### CROSS REFERENCE TO RELATED APPLICATIONS

This application claims the benefit of U.S. Provisional Application No. 60/866,208, filed Nov. 16, 2006, which is incorporated by reference in its entirety (and referred to herein with the reference number [5]).

This application is also related to the following, each of which is incorporated by reference in its entirety: [1] U.S. application Ser. No. 10/170,260, filed Jun. 13, 2002, entitled “Input-controllable Dynamic Cross-connect”; [2] U.S. application Ser. No. 10/192,118, filed Jul. 11, 2002, by entitled “Transparent, Look-up-free Packet Forwarding Method for Optimizing Global Network Throughput Based on Real-time Route Status”; [3] U.S. application Ser. No. 10/382,729, filed Mar. 7, 2003, entitled “Byte-Timeslot-Synchronous, Dynamically Switched Multi-Source-Node Data Transport Bus System”; and [4] U.S. application Ser. No. 11/245,974, filed Oct. 11, 2005, entitled “Automated, Transparent System for Remotely Configuring, Controlling and Monitoring Network Elements.”

### BACKGROUND

The invention pertains to the field of telecom network monitoring systems, and in particular to displaying network alarm status.

Acronyms used in this specification are defined below:
GUI Graphical User Interface
HW Hardware
IF Interface
NE Network Element
NMS Network Management System
PC Personal Computer
SW Software

Conventional telecom network status monitoring systems are typically made of complex arrangements of heterogeneous software subsystems, such as network element (NE) interrupt handlers, NE managers, network management communications protocol agents, network management systems (NMS) database software for storing NE status data, analyzers for processing NE status data and to monitor network defect and alarm status, and user interface (IF) software to display the network status data indicators for human network operators.

There are several complexities associated with such conventional network status monitoring systems. For example, many of these software subsystems are vendor-specific and only work with a given type of NE, a specific NMS communications protocol or a certain database system. Also, since most conventional networks are not sufficiently intelligent to automatically correct themselves from even all such defect conditions that do not require manual onsite repair for correction, human operators need to analyze various types of network status data in order to make decisions for the proper corrective actions to be completed through the NMS. Moreover, conventional monitoring systems are not transparent, i.e., they usually cannot provide direct visibility with automatic root cause resolution from the human operator interface to the NE device defect status registers holding the real-time defect status information.

Accordingly, the operational requirements for conventional network status monitoring systems are complicated. Extensive measures of various types of integration SW (i.e., middleware) are needed in between the vendor specific SW components, e.g., NE managers, NMS communication protocol agents, NMS database SW etc., in order to make the monitoring system work in an integrated manner. The various stages of data format, language and protocol conversions performed by the middleware unavoidably make these conventional systems non-transparent, as well as more complex and less flexible.

The limitations regarding the capabilities for conventional networks to self-recover even from defects that do not require manual repair require human operators to decide on and initiate corrective actions through NMS. Accordingly, conventional monitoring systems need to be able to provide to their user IFs more detailed information of the network status than only a top-level view of whether and where there are service-affecting active defects in the network. At the same time, much of the network status information provided through conventional network management and monitoring systems is redundant rather than vital, complicating the decision making by human operators while making the task overly complicated and multi-dimensional for complete SW automation.

Since it is common that there will be several alarm causing defects in the network, including several defects per each NE, at the same time even when all caused by a single root cause, without alarm filtering, the alarm status notification at the human interface is bound to get overloaded with a burst of virtually concurrent alarms whenever any defect gets activated in the network. Worse still, many conventional NEs generate interrupts and alarms based on both defect activation and de-activation, while it is common that many defects will fluctuate between active and non-active status during periods of network disturbance (e.g., high bit error rate on a given line). Consequently, complex defect filtering and alarm suppression schemes would need to be built in order to prevent the network monitoring and management system from becoming non-operational during a burst of defect and alarm activity that is common even in cases of single root cause for the defects. Such defect filtering and masking schemes in turn make the monitoring systems non-transparent.

Therefore, conventional means for network status monitoring, though complex and, as a result, costly to develop, maintain and use, are inefficient in operation, and often inherently limited in scope of the supported functionality due to the vendor-specific implementation. These problems of conventional network monitoring systems become increasingly intensified as the size of the networks grows, as the volume of potential interrupts, defects and alarms, many of which can activate concurrently, grows.

These factors create a need for innovation enabling monitoring of real-time status of service affecting alarms and their root-defects in the network.

### SUMMARY

Embodiments of the invention provide efficient systems and methods for alarm monitoring, display, notification, redundant alarm suppression and root-defect resolution in a communications network comprising a plurality of network elements (NEs).

In one embodiment, the network alarm monitoring system comprises a network management system (NMS) database for storing latest NE status files, and a graphical user interface (GUI) for displaying alarm status of the NEs. The NE status files contain a top-level NE alarm indicator, and a hierarchy of lower-level alarm status indicators including bottom-level NE defect status bits. The GUI displays the top-level NE alarm indicators as a network alarm monitoring vector, with its NE-specific elements hyperlinked at the GUI through a hierarchy of network alarms, via lower-level NE, NE-block and sub-block alarm vectors, down to the bottom-level defect status bits. The GUI thus enables hyperlink based navigation from the top-level NE alarm indicators down to the bottom-level defect status registers, facilitating efficient root defect resolution in large networks with extensive amounts of individual defects capable of causing alarms.

In an embodiment of the invention, the NEs periodically copy their latest status files to their corresponding directories at the NMS server, from where data within the NE status files is displayed by the GUI. The NE status files are binary files wherein the NE top-level alarm indicators are individual bits indicating whether the NE has active defects. Moreover, these NE status files each contain a bit vector at pre-defined position within them that represents the alarm status of the top-level functional blocks of the NE. The GUI hyperlinks the NE top-level alarm indicator bits to these NE top-level block alarm vectors, resulting in that when a given NE-specific bit in the network alarm vector at the GUI is clicked, the GUI displays the top-level block alarm vector of that NE. Furthermore, in case that a top-level block of a NE has additional alarm hierarchy below it, the bits of such blocks in the NE top-level alarm vectors at the GUI are further hyperlinked to lower-level alarm vectors at pre-defined address offsets within the NE status file, and so on, until the bottom-level defects status bits are reached for display at the GUI. The upper-level alarm indicators in the network alarm hierarchy are formed by an OR function of their lower-level alarm or defect status bits, so that, e.g., a non-active status of a given NE-specific bit in the network alarm vector tells that the corresponding NE is free from defects, whereas an active status of a given bit in a NE top-level block alarm vector tells that the corresponding block has one or more active defects.

Embodiments of the invention further provide methods for preventing unmonitored defects, e.g., non-service affecting defects, from causing alarms, and for producing pop-ups to notify the network operations staff of new NE alarms, as well as methods for minimizing the frequency of such alarm notifications, while providing a comprehensive and clear view of the network alarm status even under heavy loads of defect activations.

### BRIEF DESCRIPTION OF THE DRAWINGS

FIG. 1 is an overview of a network alarm monitoring system, in accordance with an embodiment of the invention.

FIG. 2 illustrates the contents of a NE status file containing NE alarm and defect status data, in accordance with an embodiment of the invention.

FIG. 3 illustrates an alarm display method, in accordance with an embodiment of the invention.

FIG. 4 illustrates functional examples of the alarm display logic shown in FIG. 3, in accordance with an embodiment of the invention.

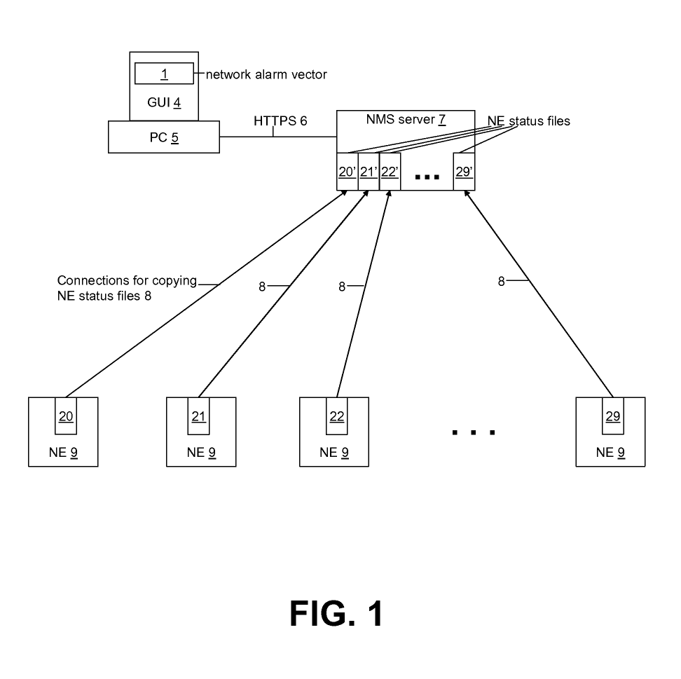

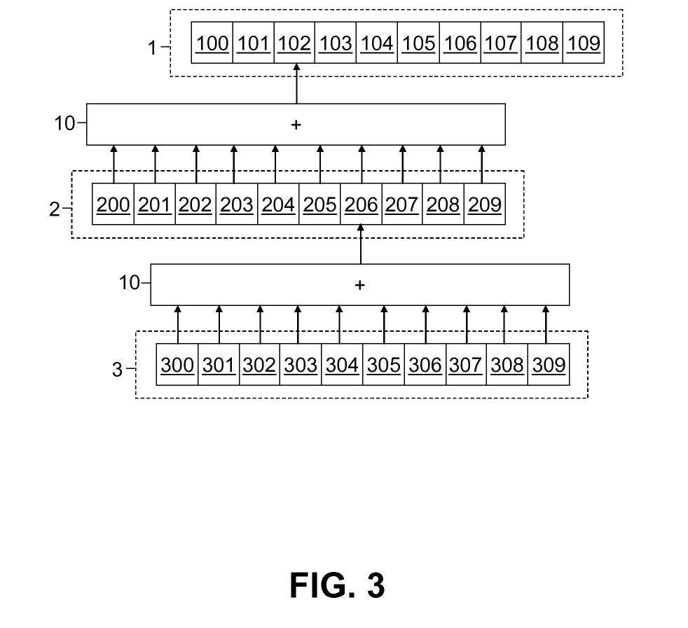

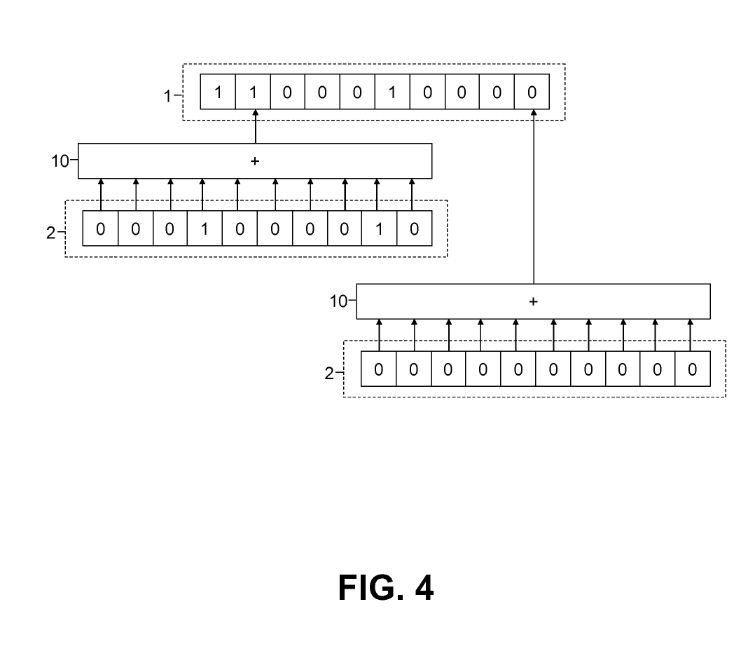

The following symbols and notations used in the drawings:
A box drawn with a dotted line indicates that the set of objects inside such a box form an object of higher abstraction level, such as in FIG. 3 an alarm vector 2 formed of its member elements 201 through 209.
Arrows between boxes in the drawings represent a path of information flow, and can be implemented by any communications means available, such as Internet or Local Area Network based connections.
Lines or arrows crossing in the drawings are decoupled unless otherwise marked.
Symbol ‘+’ represents a logic OR function.
Non-underlined binary values, i.e., 0 or 1, inside boxes, e.g., inside the elements of vector 2 in FIG. 4, present exemplary binary values of such elements.
Three dots between instances of a given object indicate an arbitrary number of instances of such an object, e.g., Network Elements (NEs) 9 in FIG. 1, repeated between the drawn instances.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

FIG. 1 presents an architectural overview of the network alarm and defect status monitoring system of present invention. At a high-level, the system presents the alarm status of a set of monitored NEs 9 on an NMS GUI 4.

In a preferred embodiment, each NE 9 periodically, e.g., once every one, five or ten seconds, copies a binary file, e.g., file 20, containing its status data to a NMS database at the NMS server 7. Each NE status file, e.g., file 21, contains a bit representing whether the NE had active defects at the time the file was copied from the local memory of the NE to the NMS database. NMS database and GUI SW display the status of these NE top-level alarm status bits in a network alarm status vector 1 at the GUI 4.

In a preferred embodiment, the NE status files 20′ through 29′ at the NMS database 7 are complete binary images of device status register states at the source NE 9 at the time that NE copied its status file to the NMS server. Consequently, the NE status files 20′, 21′, 22′ etc. comprise complete binary contents of the NE device status registers, including of all alarm and defect status registers of the NE. Note however that the phrase status register herein refers to a binary element, e.g., a bit, byte, half-word, word etc., within a NE status file, and the use of the phrase stratus register does not imply that there would have to be an actual dedicated digital storage element at the NEs for storing the contents of any given status register. It is possible that the contents of a status register, e.g., an alarm status vector or a defect status register, are produced to a NE status file via, e.g., combinatory logic at the NE, though it is also possible that NE status registers contents are stored, e.g., at flip-flop registers at the NE. That per the invention the NMS GUI 4, which displays network alarm and defect status to the system user, accesses as its network status source data directly the NE status files 20′ through 29′, which are exact copies of the actual NE status register contents in files 20 through 29, makes the network alarm monitoring and display system of the invention completely transparent, all the way from the elementary NE HW status register contents to the NMS GUI 4. Moreover, this functional system architecture of the invention eliminates the need for any messaging related to defect or alarm activations or de-activations, or any other dynamic, network data-plane event-triggered transactions related to network status monitoring, between the NMS 7 and the NEs 9, while providing comprehensive, current network status info to the NMS. It is also seen that the invention architecturally provides good scalability and stable, deterministic performance even during high loads of network defect and alarm events, since the system per the invention is based on periodic transfer of NE status files from NEs to NMS continuously and constantly during all levels of defect and alarm activity, and does not rely on any separate messaging or other software transactions for notifications of defect or alarm events between the NEs and the NMS.

A possible system implementation further comprises a PC 5 hosting the NMS GUI application, e.g., HTML based web browser 4. In such a system implementation, the GUI 4 connects to the NMS server 7 over a secure HTTP connection 6. The NMS server computer 7 in a preferred embodiment also hosts a secure NFS server, and the NEs secure NFS client applications, allowing a secure transfer of files between the NMS server 7 and the NEs 9, e.g., over Internet, including copying 8 of the NE status files 20 through 29 from the NEs to their corresponding directories at the NMS server for access by the NMS GUI 9. The copies of these NE status files, when transferred to 8 to and stored at the NMS server 7, are marked with notation 20′ through 29′ in FIG. 1. It shall be understood that there is no implied limit to the number of NEs supported by this network alarm monitoring system, but that instead this system architecture supports an arbitrary number of NEs 9 and their status files 20, 21, 22 and so on.

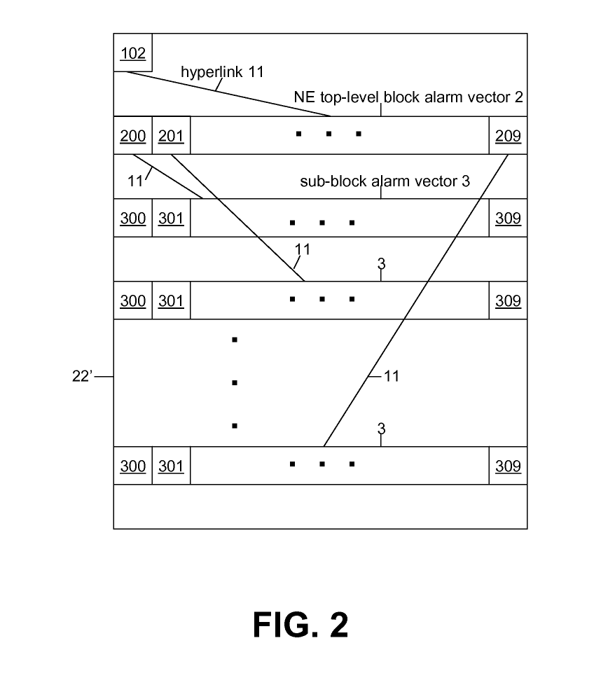

FIG. 2 illustrates contents of the NE status files, using file 22′ from FIG. 1. as an example, including a hierarchy of NE alarm vectors, and an associated hierarchical method for hyperlinking 11 NE alarm and defect status indicators. The file 22′, stored at a directory at NMS server 7 dedicated to files associated with the NE that the file was copied from, is similar in its contents to the file 22 when still stored at the local memories at its source NE. This is the case for all of the NE status files per the invention, e.g., files 20′ through 29′ in FIG. 1.

In a preferred embodiment, the NE status file, using file 22′ as an example in FIG. 2, contains a bit 102 indicating whether the NE 9 has active defects; in the case of positive logic, the NE sets this top-level NE alarm status bit 102 in its status file 22′ to binary ‘1’ when the NE has one or more active defects, and to binary ‘0’ otherwise. Logically, the NE top-level alarm status bit 102 is the output of logic OR function that has as its inputs all the bits representing the status of all monitored defects associated with the NE. In the currently preferred embodiment, the NE 9 is conceptually divided into logical blocks, such as network interface blocks, internal logic blocks, NE infrastructure block, etc., and these blocks each have an alarm status bit indicating whether the block in question has active defects at any given time. These blocks can be further divided into their internal sub-blocks, and such sub-blocks can further have their sub-block alarm status indicators, indicating whether the given sub-block has active defects, and so on down the hierarchy, until the level of the actual defect status registers in the NE HW logic is reached. Herein, the term defect refers to an elementary or bottom-level failure indicator, such as SDH/SONET Loss of Signal (dLOS), Los of Frame (dLOF) or Alarm Indication Signal (dAIS), detected by NE HW. The term alarm is used to refer to indicators of presence of lower-level alarms or defects at a given block, NE, network etc.

An efficient NE HW implementation for forming the NE, block, sub-block etc. alarm status indicator bits is that the alarm or defect status bits at the immediate lower-level in the NE alarm hierarchy are logically OR:ed to form their representative upper level alarm status indicators. For instance, the top-level NE alarm indicator bit 102 is an OR function of all the top-level block alarm indicator bits of the NE, i.e., of the top-level alarm vector 2 of the NE. Similarly, the alarm bit of each top-level block is the logic OR output of all the sub-block alarm bits 300 through 309 of the given block, and/or of the individual, bottom-level defect bits 300 through 309 of the block, depending on the internal alarm and defect hierarchy of each individual block. For example, if a block has a complete layer of sub-blocks below it, the block alarm bit, e.g., bit 201, is an OR function of all the bits 300 through 309 of its sub-block alarm vector 3. Eventually, the NE alarm hierarchy reaches down to the individual defect level status registers; e.g., a given sub-block alarm status bit can be an OR function of its sub-block defect status bit vector that has as its elements the individual bits representing the status of all monitored defects of the given block. FIG. 2 presents how the elements of upper level alarm indicators in the NE status files at the NMS server 7, e.g., file 22′, are logically hyperlinked 11 to lower-level alarm and defect vectors, e.g., the NE top-level alarm bit 102 hyperlinked 11 to the NE top-level block alarm vector 2, elements of which, e.g., bit 29, are further hyperlinked to alarm or defect vectors 3 of their corresponding functional blocks within the NE 9.

FIG. 3 illustrates key elements of the alarm display logic of present invention. In a preferred embodiment, the network alarm status vector 1 includes an element, e.g., 100, per each one of the NEs 9 being monitored, displaying whether the NE has any active defects. A straightforward implementation of this NE alarm status display is that the GUI 4 displays directly the binary status of the top-level NE alarm status bit, e.g., 101, contained within the latest copy of a NE status file, e.g., file 21′, stored at the NMS server 7. In case of positive logic based system, binary status of ‘1’ of the NE top-level alarm status bit, such as 102, indicates the presence of at least one active defect at the related NE 9, while binary status of ‘0’ indicates the absence of active defects at the NE 9 in question.

Moreover, in a preferred embodiment, the NE-specific elements 100 through 109 in FIG. 3 of the network alarm status vector 1 at the GUI 9 are hyperlinked to the top-level NE alarm status indicator vectors 2 of their corresponding NEs, i.e., to the NE top-level block alarm bit vectors 2. The bits 200, 201, 202 etc. of the NE top-level alarm vectors 2, in turn, are hyperlinked, to the bits in their local NE status file representing their related sub-block alarm or defect vector 3, according to the hyperlinking 11 shown in FIG. 2. Furthermore, in case that a given block of a NE had internal alarm hierarchy of exactly one full layer of sub-blocks, the sub-block alarm bits 300 through 309 (FIG. 2) are further hyperlinked at the GUI to their corresponding bottom-level defect status bits. The hyperlinking of such sub-block alarm bits to the bottom-level defect vectors, i.e., elementary defect vectors, of their sub-blocks is done similarly to the hyperlinking 11 of, e.g., the NE top-level alarm status vectors bits 200 through 209 to their corresponding lower-level alarm status vectors 3 per FIG. 2.

Per the invention, an upper level alarm status indicator is a logical OR function 10 output of the bits of the alarm or defect status vector below said upper level alarm bit in the network alarm hierarchy. FIG. 3 presents, as an example, how the third element 102 of the network alarm status bit vector 1 is formed as an OR function of the top-level block alarm status bits 200 through 209 of the NE in question, i.e., from NMS perspective, the third NE in the given network being monitored. Likewise, FIG. 3 presents, again as an example, how the seventh element 206 of the top-level alarm bit vector 2 of the third NE is formed by OR'ing the alarm or defect status bits 300 through 309 within that seventh block of that third NE, per the alarm hierarchy of the NE status files shown in FIG. 2. For the NE top-level block alarm bit 206, these bits 300 through 309 collectively present, directly or through further hierarchy, status of all monitored defects within the seventh block of the NE. In case that a given bit in the vector 3 presents an alarm status of a sub-block, such a bit is formed as an OR function 10 of the defect status bits within that sub-block. It is also possible that a given bit in a vector 3, or even in a vector 2, is a direct output of an individual, bottom-level defect status register. Any mix or match of alarm status bits, with further alarm or defect hierarchy below them, and individual defect status bits are also allowed within the NE alarm status vectors, such as bit vectors 2 or 3 in FIG. 3. Per the principles of invention, the alarm status vectors such as 1, 2 and 3 can have any desired number of elements i.e., bits within them, including one bit, and there can be any desirable number of sub-levels below any layer within the network alarm hierarchy. It shall also be understood that there are NE alarm vectors 2 with their appropriate alarms and defect hierarchies below them and with the relevant OR logic functions between the layers of the alarm hierarchy for each of the elements 100 through 109 in vector, even though for clarity, such a vector 2 and related logic and further hierarchy is shown for, as an example, only for the third element 102 of the vector 1.

Based on this method of hierarchically hyperlinking 11 the monitored defects in the network via logical layers such as NE, block and sub-block level alarm and defect status vectors to a top-level network status vector 1, a user of the network alarm monitoring system can intuitively navigate via a web browser 4 from the top-level network alarm status vector 1 down to the root cause level defects with only a few web-browser clicks. For instance, based on a system with in average ten NEs per a basic network, ten blocks per a NE, ten sub-blocks per block, and ten defects per sub-block, an alarm hierarchy of 10(exp 4)=10,000 individual defects is navigable with only three clicks from the NMS GUI 4, i.e., with first click to select the NE of concern, second click to select a defected block within the NE, and third click to select a sub-block with an active defect within the selected block, thus resulting in the bottom-level defect status bits of the selected sub-block getting displayed at the GUI.

Various embodiments of the alarm display and navigation methods of the invention can have various numbers of defects per a block or sub-block, various numbers, including none, of sub-block layers within each block, various numbers of blocks or sub-blocks per a given layer of the NE alarm hierarchy and various numbers of NEs per a network alarm status vector. Efficient implementations for digital hardware or software logic can be based on, e.g., base of 8 (byte), 16 (half-word), 32 (word) or 64 (double-word) for the supported number of NEs per a network, blocks or sub-blocks per a given level of NE alarm hierarchy, and individual defects within the bottom-level defect vectors.

Also, by a linear extension of the alarm hierarchy presented herein from the individual defect level to a level of NE-specific alarm status indicators 101 through 109 within a network alarm vector 1, the alarm display system and methods of the invention can be linearly scaled to additional layers above the basic network level alarm vector 1. For instance, bits of the alarm status vector 1 of such a basic network can be OR:ed to form a collective alarm status indicator bit for that basic network, thus enabling the alarm status of a group of, e.g., ten such basic networks, each comprising up to 10 NEs, to be monitored at an NMS GUI 4 via a ten-element alarm vector similar to vector 1, however with each of its elements presenting the alarm status of a basic network of, e.g., ten physical nodes rather than the alarm status of an individual network node. Thus, principles of the invention as discussed above can be efficiently extended for alarm monitoring, display, navigation and automated root defect resolution for telecom networks with any number of NEs. By utilizing the present invention, assuming alarm or defect vectors with an average of ten elements at each, finding a bottom-level defect, i.e., root cause for a top-level alarm, will take only N (an integer) clicks at the hyperlinked elements of the alarm vectors for a network with 10[exp(N+1)] possible bottom-level defects. The alarm monitoring and display architecture of the present invention is therefore very efficiently scalable for large networks.

FIG. 4 presents examples of the functionality of the alarm display method of the invention. Examples for the cases of presence and absence of lower-level alarms are shown.

The case of an indication of the presence of one or more lower-level alarms is shown using the 2^{nd} element 101 of the network level alarm vector 1. It is seen that for the output of the logical OR function 10 of the NE top-level alarm status vector 2 to be at binary logic ‘1’, at least one of the bits 201 through 209 of the vector 2 have to be at logic ‘1’. In the example of NE top-level alarm vector 2 shown for the 2^{nd} NE of the network being monitored, the 4^{th} and 9^{th} bits are at ‘1’, indicating active defects associated with logic blocks or functions represented by these bits. More generally, whenever any one or any subset, up to all, of the bits in a lower-level alarm or defect vector, such as vectors 3 or 2 in FIG. 3, are in their active values, i.e., logic ‘1’ in the case of positive logic system, their corresponding bits in the upper-level alarm vector will be at their active values, i.e., logic ‘1’ assuming the use of positive logic. Accordingly, an active value of an element in the top-level network alarm display vector 1 indicates of a presence of one or more active defects in the NE associated with said element. For example, it seen in displayed status of the network alarm vector 1, that the 1^{st}, 2^{nd} and 6^{th} NE of the ten-NE network being monitored through the GUI 4 have active, alarm-causing defects at that time.

The case of absence of lower-level alarms and defects is shown in FIG. 4 using the 10^{th} one of the monitored NEs as an example. As shown, none of the bits is active within the NE top-level alarm status vector of 2 of that 10^{th} NE. Since each of the NE top-level alarm status bits of that NE are at logic ‘0’, i.e., inactive in the case of positive logic system, the NE alarm status bit for the 10^{th} NE in the network level alarm status monitoring vector 1 is also at its inactive value of logic ‘0’. Similar to the case of the 10^{th} NE, it is seen from the top-level network alarm display vector 1 in FIG. 4 that also the 3^{rd}, 4^{th}, 5^{th}, 7^{th}, 8^{th} and 9^{th} NEs of the ten-NE network being monitored through the vector 1 displayed at the NMS GUI 4 do not have any active defects at the time being.

Thereby, enabled by the present invention, the presence or absence of active defects associated with a given NE is directly visible from the top-level network level alarm vector 1, without having to monitor or examine, either by SW programs or by a human operators, any of the lower-level alarm or defect status data of the NEs 9, regardless of how complicated or large the entire network being monitored is at any given case.

### DESCRIPTION OF PREFERRED EMBODIMENTS

The subject matter of the present invention involves an efficient, transparent and scalable system and method for displaying communications network alarm status on a network management GUI.

Per the discussion in the foregoing regarding the drawings, a preferred embodiment of the network alarm status display system of the invention comprises a web-based NMS GUI 4 for displaying the alarm status of NEs 9 of the communications network being monitored, based on NE alarm status indicators 100 through 109 within NE status files 20′ through 29′ stored at an NMS database 7. Moreover, the preferred NEs, e.g., per the reference application [5], periodically copy to the NMS server their binary status files, containing a NE top-level alarm indicator bit, such as the bit 101 in the file 21, and a logically hyperlinked 11 hierarchy of lower-level alarm and defect status indicator bit vectors, e.g., vectors 2 and 3, within the NE status files, all the way down to the bottom-level defect status registers, for indication of elementary-level defects, for example network interface defects such as transmit power level failure, loss of received signal, or NE infrastructure defects such loss of NE clock synchronization, etc. The preferred GUI displays for the human network operator the status of the top-level NE alarm indicator bits of the latest NE status files stored at the network management database on the NMS server. The preferred NMS server provides a dedicated directory location for storing the latest NE status files 20 through 29 from each of the NEs of the network being monitored, enabling an straightforward linking of the NE-specific alarm indicators in the displayed network alarm monitoring vector 1 to the top-level alarm indicator bits 100 through 109 within the NE status files at the NMS database. The preferred NE status files, e.g., per the referenced application [5], which the NEs periodically copy from their local memories to their dedicated directories at the NMS server, provide a logical hierarchy of NE-internal alarm and defect status bit vectors, providing logical system for linking their top level alarm vectors through a hierarchy of lower-level alarm indicator vectors down to the elementary defect status registers.

Furthermore, in a preferred embodiment, the NE top-level alarm status indicator bit within a NE status file is formed by a logic OR function of a bit vector of alarm indicators of the top-level functional blocks of the NE. Accordingly, the NE-specific elements of the network alarm vector displayed at the web-based GUI are hyperlinked to these NE top-level block alarm indicator bit vectors within the NE status files. Likewise, where a given top-level functional block within a NE has a layer of sub-block alarm indicators below it, the alarm indicator bit of such a block at the NE top-level block alarm vector 2 is hyperlinked via the GUI to a vector 3 of sub-block alarm indicators within that block. Similarly, in such a case, the top-level block alarm vector bits are OR function outputs of bits within the sub-block alarm indicator bit vectors of their corresponding sub-blocks, and so on through the hierarchy down to the bottom-level (i.e., elementary) defect status vectors. Generally, this hyperlinked system of network, NE, block and sub-block alarm vector continues the trough the network alarm hierarchy until the bottom-level defect status registers are reached. For instance, assuming that a given sub-block with a top-level functional block of a NE does not have further alarm hierarchy below it, but instead below the sub-block alarm indicator are the individual defect status registers of the sub-block, the bit representing such a sub-block within the sub-block alarm vector 3 of the given NE top-level block is hyperlinked at the GUI down to the individual bottom-level defect status vector of the sub-block. The sub-block alarm bit in that case naturally is an OR function of the bottom-level defect vector bits of that sub-block.

In a particular currently preferred embodiment, the top-level blocks of the NEs occupy sections or bit fields of a pre-defined size and position within the NE status files. Moreover, in such an embodiment, the sub-block alarm vectors within such blocks are at predefined positions or address offsets within their block specific sections of the NE status file. Furthermore, in such a preferred embodiment, the sub-block specific status data occupy sub-sections of pre-defined size and position within the top-level block specific sections of the NE status files. For instance, a NE status file can comprise, e.g., eight top-level block specific sections, each of for example 1024 bytes in size. The top block-level specific sections within the NE status files can further be divided into, e.g., four sub-block sections of 256 bytes each. In such an embodiment, the sub-block alarm status vectors 3 as well as the bottom-level defect vectors within the sub-block sections are at consistent positions, e.g., in the first byte address locations (i.e., at offset zero) within their (sub)sections. Thereby, in such an embodiment, the NE top-level block alarm indicator bits 100 through 101 are systematically hyperlinked at the GUI to addresses within binary NE status file given by formula 1024T, wherein in T is the index of a given bit in the NE top level block alarm vector 2. Likewise, in such a case, bits within sub-block alarm vectors of are hyperlinked to an address in the NE status file with offset increment of 256S from the address of the sub-block alarm vector, wherein S is the index of the bit within its sub-block alarm vector 3.

It is thus seen how this system enables efficient hyperlinked navigation from the top-level alarm indicators of the network down to the root-cause, i.e., bottom-level individual defect status registers of the set of NEs that comprise the network being monitored. The system thereby also facilitates an automated root-cause defect resolution, as the defected and defect-free NEs, blocks, sub-blocks etc. are directly seen via the hierarchically hyperlinked alarm status vectors, without a need to scan for possible defects through all of the NE status files.

For applications in MPLS and SDH/SONET networks, the referenced application [5] provides specifications for an example NE usable with the network alarm monitoring system and methods of the present invention, including description of the currently preferred NE alarm and defect status register hierarchy with related application notes.

It should be understood that the term NE, while often used to refer to a network equipment or node, can equally well herein be understood to refer a section of network, or a sub-network, containing multiple separate physical nodes, where appropriate. This due to that the alarm display and navigation hierarchy described herein can extend without any particular limits both upward as well as downward. For instance, in a given embodiment, bits NE top-level block alarm vectors 2 can present alarm status of separate nodes, in which case the sub-block alarm vectors 3 present the top-level alarm vectors of the nodes that comprise the NEs.

### OPERATING PRINCIPLES OF PREFERRED EMBODIMENT

The network alarm display method of present invention is based on periodically storing the latest NE status files from the NEs of the network at a NMS database, from where the binary status of NE top-level alarm indicator bits are read and displayed at a network monitoring GUI as a network alarm status monitoring vector 1 that has the NE-specific alarm indicator bits as its elements. Moreover, per discussion above, in a currently preferred embodiment, the NE-specific alarm status bits in the network alarm monitoring vector displayed at the web-based NMS GUI are hyperlinked to NE top-level block alarm indicator bit vectors 2 contained within the related NE status files stored at the NMS database. Furthermore, where top-level blocks of a NE have further alarm or defect hierarchy below them, the bits in the NE top-level alarm status vector 2 at the GUI are further hyperlinked to lower-level alarm indicator vectors 3, e.g., sub-block alarm vectors, and so on down the NE alarm hierarchy, until the elementary level defect status registers are reached.

The alarm display, notification and root-defect resolution methods of the invention in a preferred embodiment also include a capability, via the NMS GUI, and utilizing principles based on the referenced applications [4] and [5], to configure which ones of the elementary level defects that the NEs are capable of detecting, shall cause an alarm. For instance, in a particular embodiment, for each elementary defect status register bit at the NEs there is a corresponding alarm enable bit, such that when set to logic ‘1’ causes a state of logic ‘1’ of its corresponding defect status bit to be propagated to an alarm indicator at its upper level alarm status indicator vector, and when set to ‘0’ causes its corresponding defects status bit to be treated as if it was at value ‘0’ regardless of its actual value. A straightforward logic implementation for this alarm suppression feature is each elementary or bottom level defect status bit is logically AND:ed with its corresponding alarm enable bit, and the suppressible outputs of these logic AND functions are logically OR:ed to produce an alarm status indicator bit for the upper-level NE or network alarm indicator vector in the hyperlinked network alarm navigation hierarchy. These AND gates naturally mask to logic ‘0’ their corresponding alarm bits whenever the alarm enable bit is configured to logic ‘0’, while they pass the defect status in its actual state to their outputs when the alarm enable inputs are configured to ‘1’. This capability of the invention allows to suppress any non-service-affecting or non-monitored defects, e.g., defects associated with an unused network interface or function, thus preventing such non-critical defects from causing alarms. In a preferred embodiment the alarm-enable bits at the NEs are configurable via the NMS, to allow the network operator to select those of the defects at the NEs that should not cause alarms. Note further that while this feature enables to cause alarm propagation up the hierarchy only based on the defects considered as critical, i.e., defects that are being monitored for alarms, the capability for a network operator to view the actual, non-suppressed, status of all defects via the NMS GUI and its hyperlinked alarm and defect display hierarchy, is preserved.

Additionally, a preferred embodiment of the NMS GUI produces a pop-up window notification when a NE top-level alarm status indicator bit in a NE status file transitions from logic ‘0’ to ‘1’, i.e., when a previously defect-free monitored NE enters a defected state. In a particular currently preferred embodiment, such new NE alarm notification pop-ups generated by the NMS GUI based on continuously monitoring the NE top-level alarm indicator bits in the newest NE status files identify for the human network operators the specific NE that had entered a defected state. Since, as discussed above, the present invention enables suppressing non-monitored defects from causing alarms, such alarm pop-ups are generated by the GUI when a NE that previously was free of active monitored defect has new, actually monitored defect or defects activated. Thus, activation of defects configured as non-monitored will not cause NE alarm notification pop-ups. This feature of the invention eliminates unnecessary alarm pop-ups at the NMS GUI. Moreover, since the NE alarm entry pop-ups per the invention are based simply on an activation, i.e., ‘0’to ‘1’ transition of the NE top-level alarm indicator bit within each NE status file, any activations of further defects or alarms within such NEs that already had at least one active defect will not cause further alarm notification pop-ups at the GUI. This feature of the invention further minimizes the frequency of alarm notification pop-ups displayed at the NMS GUI to the user by eliminating redundant alarm notification pop-ups based on defect activations at already defected NEs (i.e., when a given NE already had its top-level alarm status indicator in its active value). As a result, the GUI of a preferred embodiment of the invention will display to the network operator a minimum number and frequency of alarm notification pop-ups that, with the hyperlinked NE alarm and defect hierarchy and the related root-defect resolution of the invention, still provides for the operator a fully sufficient level of NE alarm and defect status information. It should be noted that it is common that, whenever even one root defect gets activated, there will be a multitude of ensuing, secondary defect activations. For instance, a Los of Signal or Loss of Frame (SDH dLOS, dLOF) defect activation at a given network interface will cause a number of downstream defect activations, some of which may fluctuate between active and inactive states, such as Trace Identifier Mismatch, Payload Mismatch and Alarm Indication Signal (SDH dTIM, dPLM, dAIS) at the various level of the network protocol processing hierarchies.

The pop-up notification method of present invention based on a NE entering a defected state therefore is effective in maintaining the NMS and its network alarm status monitoring system operable even during periods of very large number of concurrent defect activations at given NE or NEs, since the invention prevents the display of redundant pop-ups based on any secondary defect activations or fluctuations, thus minimizing the peak load for the NMS and GUI resulting from network defect activity, and providing a clear view of the network alarm status to the network operator even during a burst of concurrent defect activations.

An additional feature of a preferred embodiment of the NMS GUI is that the NE specific elements in the network alarm vector that are in the active value are highlighted, with red color in the currently preferred embodiment, to allow the network operators to quickly identify those of the monitored NEs that have active defects at any given time, as well as the rest of the NEs that do not have active defects at the time. This feature of the invention, when utilized together with its other features discussed above, eliminates the need for the GUI to produce pop-ups based on de-activation of NE alarms or defects, thereby further reducing the volume of alarm status change notification pop-ups needed for producing the sufficient network alarm status information and notifications for the network operator personnel.

The phrase active defect in this specification refers to a monitored defect that is at its active value, the phrase defected state of a NE refers to a state of NE when it has at least one active defect, and correspondingly, defect-free state refers to a state when the NE has no active defects.

### REVIEW OF OPERATIONAL BENEFITS OF THE INVENTION

That the present invention provides for the network operator such an intelligently organized and filtered view of network alarm status and events, with minimized frequency of alarm notifications and intuitively navigatable, hyperlinked alarm hierarchy allowing an efficient root defect resolution, significantly improves the position of network operator personnel to make timely and correct decisions for the corrective actions required, as per the present invention, the network operators get a clear view of network alarm status even during periods of heavy load of individual defect activation and de-activations occurring in the network. Moreover, when used with intelligent NEs based on principles for self-operating network hardware per referenced applications [1], [2], [3] and [5] that are able to operate dynamically based on network data plane events even with non-dynamic network management configuration, including to recover automatically from any such network defects that do not require physical hardware repair, the invention of this patent application enables to limit the task of the network monitoring staff to identifying only such defect conditions that do require physical hardware repair work. Note, for instance, that such intelligent NEs per referenced applications [1], [2], [3] and [5], once statically configured by NMS for a given network contract, are able to automatically and dynamically reconfigure themselves to, e.g., re-route traffic around network failure or congestion points so as to maximize the network billable data throughput given the prevailing status of the physical network hardware, without requiring any action by the NMS or the network operations personnel. With such intelligent NEs, the present invention enables effectively limiting the scope of network monitoring task by network operations staff to simply initiating the response, normally manual on-site repair work, to defects that require physical hardware repair work, such as re-plugging cables or replacing hardware units, while the rest of the network and its monitoring systems works automatically.

### CONCLUSIONS

This detailed description is a specification of a currently preferred embodiment of the present invention. Specific architectural, system and logic implementation examples are provided in this and the referenced patent applications for the purpose of illustrating a currently preferred practical implementation of the invented concept. Naturally, there are multiple alternative ways to implement or utilize, in whole or in part, the principles of the invention as set forth in the foregoing.

For instance, while the presentation of the network alarm monitoring and display architecture subject matter of the present patent application, overview of which is shown in FIG. 1, is reduced to illustrating the organization its basic elements, it shall be understood that various implementations of that architecture can have any number of NEs served by an NMS server, any number of NMS servers, and any number of NMS GUIs, etc. Also, in different embodiments of the invention, the sequence of software and hardware logic processes involved with the alarm monitoring system can be changed from the specific sequence described, and the process phases of the alarm monitoring methods could be combined with others or further divided in to sub-steps, etc., without departing from the principles of the present invention. For instance, in an alternative embodiment, the NMS server could pull status files from the NEs, instead of NEs pushing their status files to the NMS server. It is also obvious to those skilled in the relevant art how the logical functions that herein are described as implemented in hardware logic, could in alternative implementations of the principles of the invention be performed by SW programs, and vice versa.

Generally, those skilled in the art will be able to develop different versions and various modifications of the described embodiments, which, although not necessarily each explicitly described herein individually, utilize the principles of the present invention, and are thus included within its spirit and scope. It is thus intended that the specification and examples be considered not in a restrictive sense, but as exemplary only, with a true scope of the invention being indicated by the following claims.

What is claimed is:

1. A system for displaying an alarm status for a set of network elements (NEs) in a communications network, the system comprising:
a network management system (NMS) server containing status data for the set of NEs, wherein the status data for each NE comprises: (i) a top-level NE alarm status indicator indicating whether the NE has an active defect, and (ii) a plurality of lower-level alarm status indicators each indicating whether an aspect of the NE has an active defect, arranged in a hierarchy from the top-level NE alarm status down to a set of bottom-level NE defect status bits; and
a graphical user interface (GUI) for displaying the alarm status for one or more of the NEs, wherein for a selected NE the GUI is configured to display the top-level NE alarm status indicator for the NE and enable hyperlink-based navigation of the status data from the top-level NE alarm status indicator down to the bottom-level defect status bits according to the hierarchy.

2. The system of claim 1, wherein the status data for each NE contained in the NMS server comprises a binary NE status file that is periodically copied from its associated NE to the NMS server.

3. The system of claim 2, wherein the top-level NE alarm status indicator of each NE is a single bit in a pre-defined position within the binary NE status file.

4. The system of claim 3, wherein the hierarchy of lower-level alarm status indicators for each NE includes a bit vector, containing one or more bits and referred to as a NE top-level alarm vector, located at a pre-defined position within the binary NE status file, with bits within the NE top-level alarm vector representing the alarm status of their related top-level functional blocks of the NE.

5. The system of claim 4, wherein the top-level NE alarm status indicators displayed at the GUI are hyperlinked to the NE top-level alarm vectors of their corresponding NEs.

6. The system of claim 5, wherein the hierarchy of lower-level alarm status indicators for each NE includes further includes bit vectors, containing one or more bits and referred to as elementary defect vectors, representing status of the bottom-level defect status bits of the NE, and located at a pre-defined positions within the binary NE status file.

7. The system of claim 6, wherein the bits in the NE top-level alarm vectors are further hyperlinked through the hierarchy of lower-level alarm status indicators down to the elementary defect vectors.

8. The system of claim 1, wherein at least one of the NEs comprises multiple separate physical network nodes.

9. The system of claim 1, wherein the NMS server further contains an upper-level alarm status indicator for a subset of one or more and up to all of the set of NEs, wherein the upper-level alarm status indicator is formed as a logical OR function of the top-level NE alarm status indicators of the subset of the NEs.

10. The system of claim 1, wherein the NE top-level alarm indicator is as a logical OR function output of the set of bottom-level defect status bits of the NE.

11. The system of claim 4, wherein bits of the NE top-level alarm vectors are formed as a logical OR functions of their corresponding lower-level alarm status indicators.

12. The system of claim 2, wherein the binary NE status files at the NMS server are complete binary copies of their corresponding NE device status register contents.

13. A method for displaying a network alarm status for a network that includes a plurality of network elements (NEs), the method comprising:
storing status data for a set of the NEs, the status data comprising, for each NE:
a top-level NE alarm status indicator indicating whether the NE has an active defect, and
a plurality of lower-level alarm status indicators each indicating whether an aspect of the NE has an active defect, the lower-level alarm status indicators arranged in a hierarchy from the top-level NE alarm status down to a set of elementary-level defect status bits;
displaying via a graphical user interface the top-level NE alarm status indicators for one or more of the NEs, wherein one or more of the top-level NE alarm status indicators each includes one or more hyperlinks to the corresponding lower-level alarm status indicators according to the corresponding hierarchy; and
responsive to receiving a user selection of a hyperlink, displaying the lower-level alarm status indicators for the corresponding top-level NE alarm status indicator according to the hierarchy.

14. The method of claim 13, further comprising:
suppressing in the status data any un-monitored defects at the NEs to prevent activations of such un-monitored defects from causing alarms.

15. The method of claim 14, wherein the un-monitored defects are suppressed using configurable, defect-specific alarm-enable control bits.

16. The method of claim 13, further comprising:
producing an alarm notification based on an activation of a top-level NE alarm status indicator.

17. The method of claim 16, wherein the alarm notification comprises pop-up windows.

18. The method of claim 17, wherein the pop-up window for the alarm notification identifies the NE associated with the alarm.

19. The method of claim 13, further comprising:
dynamically highlighting with an alarm indication color any top-level NE alarm status indicators that indicate an active defect in the corresponding NE.

20. The method of claim 13, wherein the status data comprise a binary file representing NE status register contents.
